(19) United States
(12) Patent Application Publication
(10) Pub. No.: US 2026/0154120 A1
(43) Pub. Date: Jun. 4, 2026

(54) Execution Control System

(71) Applicants: Julia Laera, Fort Lauderdale, FL (US); Antonio Laera, Fort Lauderdale, FL (US); Vito Antonio Laera, Fort Lauderdale, FL (US)

(72) Inventors: Julia Laera, Fort Lauderdale, FL (US); Antonio Laera, Fort Lauderdale, FL (US); Vito Antonio Laera, Fort Lauderdale, FL (US)

(21) Appl. No.: 19/458,705

(22) Filed: Jan. 24, 2026

(51) Int. Cl. G06F 9/50

(52) U.S. Cl. CPC G06F 9/5027

(57) ABSTRACT

A computer-implemented execution control system is disclosed. The system enforces execution eligibility, progression, and termination using machine-enforced execution states evaluated against machine-readable execution specifications. Execution is prevented unless a valid execution specification exists and is accepted. Execution resources, including time associated with execution participants, are treated as execution-limiting resources whose allocation and release are enforced by the system. Execution activity is permitted only in accordance with predefined execution conditions and state transitions. During execution, the system generates execution records in response to enforced execution state transitions and stores the records in a persistent execution ledger suitable for traceability and verification. The system operates independently of task scheduling, workflow ordering, or optimization logic, and provides a technical mechanism for controlling execution based on machine-evaluated conditions.

### TECHNICAL FIELD

The present disclosure relates to computer-implemented execution control systems. More specifically, the disclosure relates to systems and methods that enforce whether execution may occur, progress, or terminate based on machine-enforced conditions.

### BACKGROUND

Existing computer-implemented systems typically permit execution to proceed once an activity is initiated. Such systems often emphasize scheduling, ordering, or post-hoc recording of activity. These approaches do not enforce execution refusal prior to execution, nor do they ensure that execution occurs only under formally defined, machine-evaluated conditions.

### SUMMARY OF THE DISCLOSURE

Disclosed herein is an execution control system that enforces execution eligibility, progression, and termination using machine-enforced execution states evaluated against machine-readable execution specifications. Execution is prevented unless a valid execution specification exists and is accepted. Execution resources, including time associated with execution participants, are enforced as execution-limiting resources whose allocation and release are controlled by the system.

The execution control system described herein does not perform task scheduling, workflow optimization, participant ranking, marketplace coordination, or outcome evaluation. The system enforces execution eligibility and progression based on machine-evaluated conditions and does not determine efficiency, desirability, or performance of execution.

### System Overview

The execution control system comprises one or more processors and memory storing instructions that perform machine-enforced execution control operations. The operations include evaluating execution specifications, controlling execution state transitions, enforcing execution refusal conditions, and generating execution records derived from execution state transitions.

The execution control operations described herein may be implemented using software, firmware, or combinations thereof, and may operate within a single computing system or across distributed computing environments.

### Definitions as Used Herein

An execution specification refers to a machine-readable control artifact that defines a bounded execution context evaluated by the execution control system prior to execution.

An execution state refers to a discrete machine-evaluated condition that governs whether execution actions are permitted or refused.

Execution control refers to machine-enforced permission, refusal, or termination of execution based on predefined conditions.

An execution ledger refers to a persistent record of execution events generated in response to enforced execution state transitions.

### EXECUTION SPECIFICATIONS

Execution specifications are machine-readable execution control artifacts defining a bounded execution context. The execution context includes execution scope, temporal parameters, participant roles, constraints, permissions, and acceptance conditions. Execution specifications are generated prior to execution and evaluated by the execution control system before execution is permitted.

### Execution Control and State Enforcement

The execution control system enforces execution using predefined execution states. Execution actions are permitted only when the system is in an authorized execution state. Transitions between execution states are enforced by the system based on execution specifications and predefined execution conditions.

In one example, an execution initially exists in a non-authorized state in which execution actions are refused. Upon generation and acceptance of a valid execution specification, the execution transitions to an authorized state in which execution actions may occur. During execution, the system enforces execution constraints while in an executing state. Upon completion or violation of execution conditions, the execution transitions to a terminated state in which further execution actions are refused.

### Multi-Participant Execution

In some embodiments, execution involves multiple participants. Additional participants are introduced during execution only in accordance with the execution specification and enforced execution constraints.

### Execution Ledger and Technical Evidence

The execution control system generates execution records in response to enforced execution state transitions. The records are stored in a persistent execution ledger that provides technical evidence suitable for traceability, audit, and verification.

### ADVANTAGES

The disclosed execution control system enforces execution refusal prior to unauthorized execution, prevents execution outside defined execution conditions, and generates causally derived execution evidence. The system operates independently of scheduling, workflow ordering, or optimization logic.

1. Execution Control System. An execution control system, comprising one or more processors and memory storing instructions that, when executed, cause the system to: (a) performing machine-enforced execution control operations, including implementing state-based execution control logic to authorize, block, and record execution based on execution state and time-bound authorization; (b) representing execution resources associated with one or more agents, including human time, availability, and participation, as execution-limiting resources whose allocation and release are enforced by the system; (c) generate an execution specification created by one or more agents, the execution specification defining a bounded execution context including execution scope, temporal parameters, participant roles, constraints, permissions, and acceptance conditions, and identifying one or more agents associated with the execution; (d) wherein one or more agents are people, legal entities, or organizational constructs capable of authorizing execution, controlling execution mechanisms, and holding responsibility for resulting execution outcomes; (e) enforce a specification-first execution lock that prevents initiation of execution, allocation of execution resources, or recording of execution activity unless the execution specification is explicitly generated and accepted by one or more agents; (f) associate, based on a machine-readable execution specification created by one or more agents and evaluated by the execution control system, one or more execution participants or execution resources with an execution, the association being determined according to availability, role compatibility, and constraints defined by the execution specification and accepted by one or more agents; (g) controlling execution by permitting allocation of execution resources associated with one or more agents only in accordance with the execution specification, wherein human time, availability, and participation are enforced by the system as execution-limiting resources rather than descriptive task attributes; and (h) generate and record execution activity associated with the execution specification as system-generated execution signals generated in response to predefined execution state transitions, the execution signals being suitable for traceability and post-execution verification.

2. Execution Specification Generation and Management Method. A computer-implemented method for creating execution specifications and coordinating execution pursuant thereto using time associated with one or more agents as a first-class executable resource, the method comprising: (a) receiving, by an execution control system, execution specification input describing a desired outcome requiring execution associated with one or more agents, the input being used to create an execution specification for coordinating execution pursuant to the execution specification; (b) wherein one or more agents are people or legal entities capable of controlling execution mechanisms, authorizing execution, and holding responsibility for resulting execution outcomes, the agent providing execution specification input used to create execution specifications; (c) defining an execution specification as a machine-readable execution control artifact evaluated by the execution control system created by one or more agents, the execution specification comprising a bounded execution context including execution scope, temporal parameters, participant roles, constraints, permissions, and acceptance conditions; (d) prior to execution, enforcing, by an execution control system, an execution lock that prevents initiation of execution, allocation of execution resources, or recording of execution activity unless execution is authorized pursuant to an execution specification that is generated by one or more agents and accepted by one or more agents, regardless of the identity of the agents; (e) associating, by an execution control system, execution participants or execution resources exclusively pursuant to the execution specification, such that allocation, control, and execution occur only within the bounded execution context defined by the execution specification; (f) assigning, by an execution control system, one or more execution participants associated with one or more agents to an execution based on availability, role compatibility, and constraints defined by the execution specification; (g) coordinating execution, by an execution control system, by permitting allocation of time associated with one or more agents only in accordance with the execution specification, wherein the time associated with the one or more agents is enforced by the execution control system as a governing execution resource rather than an attribute of a task; and (h) generating and recording, by an execution control system, system-generated execution signals generated in response to predefined execution state transitions associated with the execution specification, the execution signals being suitable for traceability, audit, and post-execution verification.

3. Multi-Participant Execution System for Execution Specifications. A multi-participant execution system for executing pursuant to execution specifications, comprising one or more processors having memory storing instructions that, when executed, cause the system to: (a) initiating execution pursuant to an execution specification with a first participant identified by the execution specification; (b) introducing, pursuant to the execution specification, one or more additional participants to the execution after initiation, the additional participants being specified by the execution specification; (c) wherein a participant is an execution actor occupying a function specified by the execution specification; (d) wherein the execution specification is a machine-readable execution control artifact applied by the execution system during execution that defines execution parameters for the execution; (e) coordinating execution among the participant or participants by applying the execution parameters defined by the execution specification, including enforcing execution constraints during execution; and (f) progressing execution in accordance with the execution specification by advancing execution through defined execution states until completion of the execution.

4. Execution Ledger and Technical Evidence System. A system for capturing, storing, and managing execution data produced during execution pursuant to an execution specification, comprising one or more processors having memory storing instructions that, when executed, cause the system to; (a) capturing, by the system, system-generated execution data produced during execution pursuant to an execution specification, including execution events and execution state transitions associated with the execution; (b) wherein execution data comprises system-generated data derived from execution pursuant to the execution specification, including execution events, execution state transitions, participant involvement, and execution timing information; (c) storing the captured execution data in a persistent execution ledger that records execution events and execution state transitions in an ordered manner associated with the execution specification; and (d) providing access to the stored execution data to enable reconstruction, review, and subsequent reuse of execution information associated with the execution specification.

5. The system of claim 1, wherein the execution control system enforces execution by preventing initiation, allocation, or recording of execution unless an execution specification is generated and accepted.

6. The system of claim 1, wherein execution control is performed across distributed computing resources.

7. The system of claim 1, wherein execution control is performed in real time based on execution state.

8. The system of claim 1, wherein the execution control system applies time-based constraints defined by the execution specification.

9. The system of claim 1, wherein execution control includes controlling execution progression in accordance with the execution specification across multiple participants.

10. The system of claim 1, wherein execution control includes enforcing execution termination conditions defined by the execution specification.

11. The method of claim 2, wherein execution specification input is validated prior to creation of the execution specification.

12. The method of claim 2, wherein execution specification input is compiled into a machine-readable execution specification only if validation succeeds.

13. The method of claim 2, wherein execution specifications are created as reusable execution templates.

14. The method of claim 2, wherein execution specifications are versioned and stored for subsequent reuse.

15. The method of claim 2, wherein execution specifications are modified based on execution outcomes.

16. The system of claim 3, wherein execution parameters applied during execution include ordering, timing, dependency, or priority parameters defined by the execution specification.

17. The system of claim 3, wherein execution parameters are dynamically adjusted during execution.

18. The system of claim 3, wherein execution includes reassignment of participant functions during execution.

19. The system of claim 3, wherein execution specifications are optimized during execution based on execution state.

20. The system of claim 3, wherein optimized execution specifications are stored for subsequent execution.

21. The system of claim 4, wherein execution data is stored in an append-only execution ledger.

22. The system of claim 4, wherein execution data includes timestamps associated with execution state transitions.

23. The system of claim 4, wherein execution data is indexed by execution specification.

24. The system of claim 4, wherein execution data is indexed by participant.

25. The system of claim 4, wherein execution data is retained for audit or verification purposes.

26. The system of claim 3, wherein execution data captured during execution is stored in the persistent execution ledger.

27. The system of claim 4, wherein stored execution data is used to reconstruct execution state transitions.

28. The method of claim 2, wherein execution specifications are generated using stored execution data stored in the persistent execution ledger.

29. The system of claim 3, wherein execution specifications stored in the persistent execution ledger are reused to initiate subsequent executions.

30. The system of claim 1, wherein execution control, specification generation, execution, and execution data storage are performed across a distributed system.
